(19) United States
(12) Patent Application Publication
(10) Pub. No.: US 2020/0029045 A1
(43) Pub. Date: Jan. 23, 2020

(54) SOLID-STATE IMAGING DEVICE AND ELECTRONIC APPARATUS

(71) Applicant: SONY SEMICONDUCTOR SOLUTIONS CORPORATION, KANAGAWA (JP)

(72) Inventor: KOJI ENOKI, KANAGAWA (JP)

(21) Appl. No.: 16/485,664

(22) PCT Filed: Feb. 19, 2018
(86) PCT No.: PCT/JP2018/005649

§ 371 Date: Aug. 13, 2019

(30) Foreign Application Priority Data
Mar. 1, 2017 (JP) 2017-038176

(51) Int. Cl. H04N 5/378; H04N 5/3745

(52) U.S. Cl. CPC H04N 5/378; H04N 5/3745

(57) ABSTRACT

The present technology relates to a solid-state imaging device and an electronic apparatus that enable readout to be performed at higher speed by shortening the processing time for AD conversion. Provided is a solid-state imaging device including: a pixel array unit in which pixels each having a photoelectric conversion unit are two-dimensionally arranged in a matrix, and column signal lines are wired for each column in the matrix arrangement of the pixels; and an AD conversion unit that converts signals output via the column signal lines, in which pixel sharing in units of a predetermined number of pixels is fulfilled by sharing a charge-voltage conversion unit between the photoelectric conversion units of a plurality of the pixels, and, when a digital signal according to a first charge of a first pixel among the first pixel and a second pixel constituting a sharing pixel to be AD-converted is determined in the AD conversion unit, the charge-voltage conversion unit of the sharing pixel adds the first charge from the first pixel and a second charge from the second pixel. The present technology can be applied to, for example, a CMOS image sensor of a column AD method using correlated double sampling (CDS).

### TECHNICAL FIELD

The present technology relates to a solid-state imaging device and an electronic apparatus, and more particularly to a solid-state imaging device and an electronic apparatus capable of performing readout at higher speed by shortening the processing time for AD conversion.

### BACKGROUND ART

A complementary metal oxide semiconductor (CMOS) image sensor is known that performs AD conversion for each column with respect to pixels (unit pixels) arranged two-dimensionally in a matrix.

As a technology for improving the imaging speed of this type of image sensor, for example, Patent Document 1 and Patent Document 2 have been proposed.

Patent Document 1 discloses a column AD method using correlated double sampling (CDS). Furthermore, Patent Document 2 discloses a method of AD-converting a voltage obtained by combining a second pixel with a first pixel by nondestructive readout after AD-converting the first pixel in a floating diffusion (FD) sharing pixel block.

### CITATION LIST

### Patent Document

Patent Document 1: Japanese Patent Application Laid-Open No. 2005-278135
Patent Document 2: Japanese Patent Application Laid-Open No. 2006-80937

### SUMMARY OF THE INVENTION

### Problems to be Solved by the Invention

Incidentally, in an image sensor such as the CMOS image sensor, in order to implement slow motion capturing and to improve focal plane distortion and the like, higher speed readout is required.

The present technology has been made in view of such a situation, and is intended to enable readout to be performed at higher speed by shortening the processing time for AD conversion.

### Solutions to Problems

A solid-state imaging device according to one aspect of the present technology is a solid-state imaging device including: a pixel array unit in which pixels each having a photoelectric conversion unit are two-dimensionally arranged in a matrix, and column signal lines are wired for each column in the matrix arrangement of the pixels; and an AD conversion unit that converts signals output via the column signal lines into digital signals from analog signals, in which pixel sharing in units of a predetermined number of pixels is fulfilled by sharing a charge-voltage conversion unit for converting a charge detected by the photoelectric conversion unit into a voltage, between the photoelectric conversion units of a plurality of the pixels, and, when a digital signal according to a first charge detected by a first photoelectric conversion unit of a first pixel among the first pixel and a second pixel constituting a sharing pixel to be AD-converted is determined in the AD conversion unit, the charge-voltage conversion unit of the sharing pixel adds the first charge from the first photoelectric conversion unit of the first pixel and a second charge from a second photoelectric conversion unit of the second pixel.

An electronic apparatus according to one aspect of the present technology is an electronic apparatus equipped with a solid-state imaging device including: a pixel array unit in which pixels each having a photoelectric conversion unit are two-dimensionally arranged in a matrix, and column signal lines are wired for each column in the matrix arrangement of the pixels; and an AD conversion unit that converts signals output via the column signal lines into digital signals from analog signals, in which pixel sharing in units of a predetermined number of pixels is fulfilled by sharing a charge-voltage conversion unit for converting a charge detected by the photoelectric conversion unit into a voltage, between the photoelectric conversion units of a plurality of the pixels, and, when a digital signal according to a first charge detected by a first photoelectric conversion unit of a first pixel among the first pixel and a second pixel constituting a sharing pixel to be AD-converted is determined in the AD conversion unit, the charge-voltage conversion unit of the sharing pixel adds the first charge from the first photoelectric conversion unit of the first pixel and a second charge from a second photoelectric conversion unit of the second pixel.

In the solid-state imaging device and the electronic apparatus according to one aspect of the present technology, when a digital signal according to a first charge detected by a first photoelectric conversion unit of a first pixel among the first pixel and a second pixel constituting a sharing pixel to be AD-converted is determined in the AD conversion unit, the first charge from the first photoelectric conversion unit of the first pixel and a second charge from a second photoelectric conversion unit of the second pixel are added in a charge-voltage conversion unit of the sharing pixel.

Note that the solid-state imaging device and the electronic apparatus according to one aspect of the present technology each may be an independent device or an internal block constituting one device.

### Effects of the Invention

According to one aspect of the present technology, readout can be performed at higher speed by shortening the processing time for AD conversion.

Note that the effects described herein are not necessarily limited and any effects described in the present disclosure may be applied.

### BRIEF DESCRIPTION OF DRAWINGS

FIG. 1 is a timing chart illustrating timings of AD conversion and FD addition of a conventional method.

FIG. 2 is a diagram illustrating a configuration example of a solid-state imaging device according to a first embodiment.

FIG. 3 is a timing chart illustrating timings of AD conversion and FD addition in the first embodiment.

FIG. 4 is a timing chart illustrating timings of addition trigger signals and FD addition in the first embodiment.

FIG. 5 is a diagram illustrating a configuration example of a solid-state imaging device according to a second embodiment.

FIG. 6 is a timing chart illustrating timings of AD conversion and FD addition in the second embodiment.

FIG. 7 is a timing chart illustrating timings of addition trigger signals and FD addition in the second embodiment.

FIG. 8 is a diagram illustrating a configuration example of an electronic apparatus equipped with a solid-state imaging device to which the present technology is applied.

FIG. 9 is a diagram illustrating examples of use of an image sensor.

### MODE FOR CARRYING OUT THE INVENTION

Hereinafter, embodiments of the present technology will be described with reference to the drawings. Note that the description will be given in the following order.

1. Outline of Present Technology

2. First Embodiment: Basic Configuration

3. Second Embodiment: Configuration using Two RAMP Waves

4. Variations

5. Configuration of Electronic Apparatus

6. Examples of Use of Image Sensor

### 1. Outline of Present Technology

(Conventional Method)

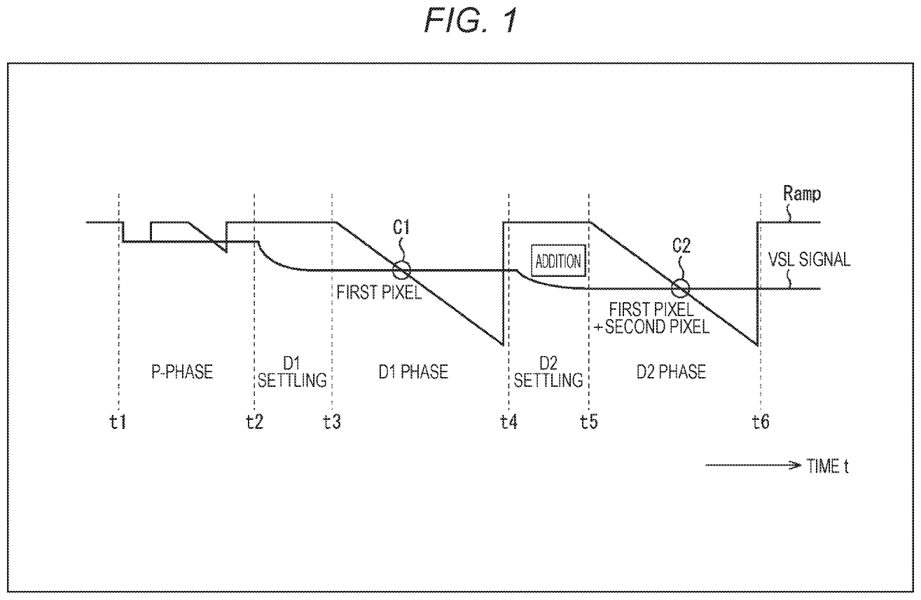

FIG. 1 is a timing chart illustrating timings of AD conversion and FD addition of a conventional method.

FIG. 1 illustrates timings of AD conversion and FD addition in a case where a column AD method using correlated double sampling (CDS) is adopted and pixel sharing in which floating diffusion (FD) is shared by photodiodes of a plurality of pixels is fulfilled in a general CMOS image sensor.

Note that, for convenience of explanation, it is assumed in the description of FIG. 1 that pixels sharing a floating diffusion in a FD sharing pixel block are referred to as a first pixel and a second pixel, and the first pixel and the second pixel have a first photodiode and a second photodiode, respectively.

Furthermore, it is assumed that a ramp wave (Ramp) from a digital-analog converter (DAC) and a vertical signal line (VSL) signal from a VSL connected to a sharing pixel are input to a comparator of an AD conversion unit of the column AD method using correlated double sampling (CDS) and compared.

In FIG. 1, the ramp wave (Ramp) from the DAC and the VSL signal from the vertical signal line VSL, which are input to the comparator of the AD conversion unit, are represented in time series. Furthermore, in FIG. 1, the direction of time is expressed as a direction from the left side to the right side of FIG. 1.

At time t1, once a reset transistor of the sharing pixel is put into the on-state, the floating diffusion of the sharing pixel is reset. With this action, a reset level Srst is read out during a P-phase period from time t1 to time t2.

Next, after a D1 settling period from time t2 to time t3, once a transfer transistor of the first pixel is put into the on-state, a pixel signal Sa according to a signal charge QA accumulated in the first photodiode is transferred to the floating diffusion. Then, in this floating diffusion, a potential according to the amount of the signal charge QA is generated and is output (applied) to the vertical signal line VSL by an amplification transistor and a select transistor of the sharing pixel.

With this action, a pixel signal level SA according to the signal charge QA is read out during a D1 phase period from time t3 to time t4. Then, an offset component is removed by taking a difference between the pixel signal level SA at the time of readout in the D1 phase and the reset level Srst at the time of readout in the P-phase, and a true signal component Sa can be obtained.

Next, when a signal charge QB accumulated in the second photodiode of the second pixel is read out after a D2 settling period from time t4 to time t5, the signal charge QB is read out from the second photodiode without resetting the floating diffusion by the reset transistor.

In other words, the signal charge QB accumulated in the second photodiode is transferred once the transfer transistor of the second pixel is put into the on-state, and joined with the signal charge QA detected by the first photodiode, which has already been accumulated in the floating diffusion. At this time, the floating diffusion is put into a state in which a combined charge QAB obtained by combining the signal charges QA and QB detected by the two photodiodes is accumulated.

In this manner, the signal charge QA detected by the first photodiode in the first pixel and the signal charge QB detected by the second photodiode in the second pixel are added in the floating diffusion, and a state is brought about in which a signal charge amount equivalent to the two pixels, namely, the first pixel and the second pixel, is accumulated. Then, in this floating diffusion, a potential according to the charge amount of the combined charge QAB is generated and is output (applied) to the vertical signal line VSL by the amplification transistor and the select transistor.

Thereafter, in a D2 phase period from time t5 to time t6, a pixel signal level SB according to the signal charge QB detected by the second photodiode is read out. In this case, however, since the floating diffusion is in a state in which the combined charge QAB made up of the signal charges QA and QB detected by the two photodiodes is accumulated as described above, a pixel signal level SAB according to the combined charge QAB is read out here.

Therefore, an offset component is removed by taking a difference between the pixel signal level SAB at the time of readout in the D2 phase and the reset level Srst at the time of readout in the P-phase, and a true signal component Sab can be obtained. Furthermore, a pixel signal Sb (true signal component Sb) according to the signal charge QB detected by the second photodiode can be obtained by taking a difference between a combined component Sab (true signal component Sab) and the pixel signal Sa (true signal component Sa).

Here, in the AD conversion unit, a comparison action between a signal voltage Vx of the VSL signal from the vertical signal line (VSL) and a reference voltage Vref dependent on the ramp wave (Ramp), which are input to the comparator, is performed by the comparator, and an output signal Vco at a level according to the comparison result is output.

Specifically, in the comparator, when the signal voltage Vx of the VSL signal and the reference voltage Vref of the ramp wave become equal (intersect with each other as in C1 or C2 in FIG. 1), the polarity of the output signal Vco is inverted and, for example, in a case where the reference voltage Vref is higher than the signal voltage Vx, the output signal Vco is placed at an H level, while the output signal Vco is placed at an L level in a case where the reference voltage Vref is equal to or lower than the signal voltage Vx. This output signal Vco from the comparator is counted by a counter in the subsequent stage.

In this manner, in the column AD method using correlated double sampling (CDS), the reset level Srst is read out during the P-phase period, and the comparison action between the relevant signal voltage Vx and the reference voltage Vref is performed such that the resultant output signal Vco is counted. Furthermore, in addition to the reset level Srst, the pixel signal level SA is read out during the D1 phase period, and the comparison action between the relevant signal voltage Vx and the reference voltage Vref is performed such that the resultant output signal Vco is counted.

Moreover, in addition to the reset level Srst, the pixel signal level SAB according to the combined charge QAB made up of the signal charges QA and QB is read out during the D2 phase period, and the comparison action between the relevant signal voltage Vx and the reference voltage Vref is performed such that the resultant output signal Vco is counted.

Here, in the conventional method using a general CMOS image sensor, after the D1 phase period from time t3 to time t4, in the floating diffusion, the signal charge QA detected by the first photodiode of the first pixel and the signal charge QB detected by the second photodiode of the second pixel are joined (FD addition is performed) simultaneously for all the sharing pixels for each group of sharing pixels in the same one line in the row direction.

Therefore, in the conventional method using a general CMOS image sensor, it takes a certain amount of time to start FD addition, and a higher speed readout is still required.

For this reason, the present technology focuses attention on the time until the start of the FD addition and makes a proposition to shorten the processing time for AD conversion by making the start time of the FD addition as earlier as possible, and to enable readout to be performed at higher speed. Hereinafter, the contents of the present technology will be described with reference to specific embodiments.

### 2. First Embodiment

(Configuration of Solid-State Imaging Device)

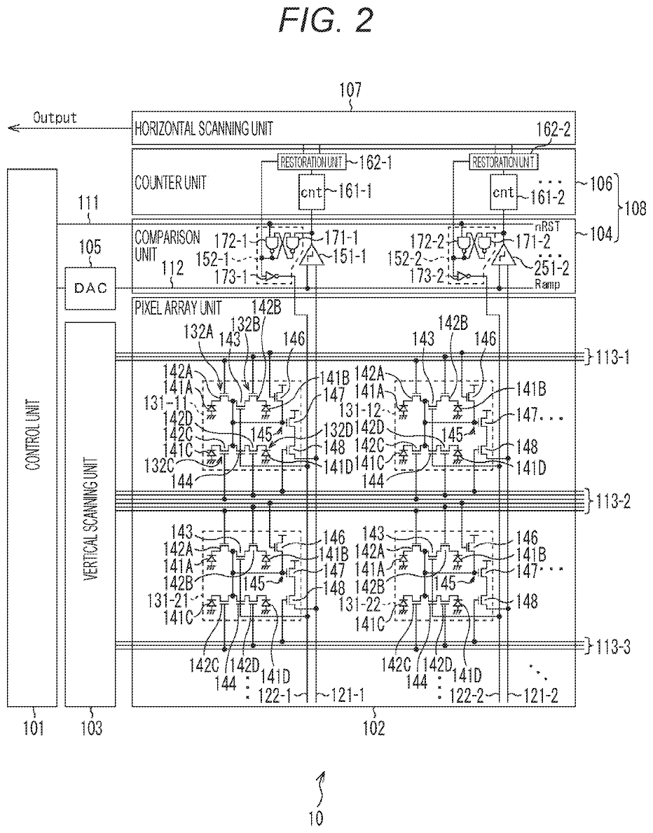

FIG. 2 is a diagram illustrating a configuration example of a solid-state imaging device according to a first embodiment.

A CMOS image sensor 10, which is an example of the solid-state imaging device, takes in incident light (image light) from a subject via an optical lens system (not illustrated), and converts the light amount of the incident light formed on an imaging surface into electrical signals in units of pixels to output the converted electrical signals as imaging data.

In FIG. 2, the CMOS image sensor 10 is configured from a control unit 101, a pixel array unit 102, a vertical scanning unit 103, a comparison unit 104, a DAC 105, a counter unit 106, and a horizontal scanning unit 107. Furthermore, the comparison unit 104 and the counter unit 106 constitute an AD conversion unit 108.

The control unit 101 controls the action of each unit of the CMOS image sensor 10.

Furthermore, the control unit 101 generates a clock signal and a control signal serving as references of actions of the vertical scanning unit 103, the comparison unit 104, the DAC 105, and the like, on the basis of various signals such as a vertical synchronization signal, a horizontal synchronization signal, and a master clock signal. The control unit 101 outputs the generated clock signal and control signal to the vertical scanning unit 103, the comparison unit 104, the DAC 105, and the like.

In the pixel array unit 102, a plurality of pixels (unit pixels) is two-dimensionally arranged in a matrix. Each pixel in the pixel array unit 102 is configured from a photodiode (PD) as a photoelectric conversion unit and a pixel transistor included therein.

Here, in the pixel array unit 102, pixel sharing in units of a predetermined number of pixels is fulfilled by sharing a floating diffusion (FD), which is a diffusion layer having parasitic capacitance, between the photodiodes of a plurality of pixels.

For example, in the pixel array unit 102, if a sharing pixel 131 in an i-th row and a j-th column is represented as a sharing pixel 131-ij, sharing pixels 131-11, 131-21, . . . , 131-i1 are connected to a vertical signal line 121-1. These sharing pixels 131 are each configured so as to share the floating diffusion (FD) among four pixels (the photodiodes of the four pixels).

Furthermore, the sharing pixels 131-12, 131-22, . . . , 131-i2 are connected to a vertical signal line 121-2, and these sharing pixels 131 are each configured so as to share the floating diffusion (FD) among four pixels (the photodiodes of the four pixels).

In other words, in the pixel array unit 102, the sharing pixel 131-ij connected to a vertical signal line 121-j is configured as four-pixel sharing in which the floating diffusion (FD) is shared among four pixels (the photodiodes of the four pixels) as an FD sharing pixel block.

Among the four pixels in the sharing pixel 131-ij, a first pixel 132A has a photodiode 141A, and the signal charge is transferred to a floating diffusion 145 by a transfer transistor 142A. However, in the transfer transistor 142A, a transfer signal (TRG) from the vertical scanning unit 103 is input to a gate electrode of the transfer transistor 142A via a control line 113-1, and the on/off action is controlled.

Furthermore, among the four pixels, a second pixel 132B has a photodiode 141B and a transfer transistor 142B, a third pixel 132C has a photodiode 141C and a transfer transistor 142C, and a fourth pixel 132D has a photodiode 141D and a transfer transistor 142D.

Also in the second pixel 132B to the fourth pixel 132D, the signal charge accumulated in the photodiode 141 (141B, 141C, 141D) is transferred to the floating diffusion 145 by the transfer transistor 142 (142B, 142C, 142D).

Note that, when the signal charge accumulated in the photodiode 141B of the second pixel 132B is transferred to the floating diffusion 145, not only the transfer transistor 142B but also a transfer transistor 143 needs to be put into the on-state.

Furthermore, similarly, when the signal charge accumulated in the photodiode 141D of the fourth pixel 132D is transferred to the floating diffusion 145, not only the transfer transistor 142D but also a transfer transistor 144 needs to be put into the on-state.

Here, although details will be described later, in the transfer transistors 143 and 144, an addition trigger signal (AT) from the comparison unit 104 (an addition trigger signal generation unit 152-j of the comparison unit 104) is input to gate electrodes of the transfer transistors 143 and 144 via a trigger signal line 122-j, and the on/off action is controlled.

Furthermore, in the sharing pixel 131-ij, a reset transistor 146 performs the on/off action in response to a reset signal (RST) input from the vertical scanning unit 103 via the control line 113-1, whereby the floating diffusion 145 is reset. In the floating diffusion 145, a potential (FD potential) according to the amount of signal charge from each photodiode 141 (141A, 141B, 141C, 141D) of the sharing pixel 131-ij is obtained.

In an amplification transistor 147, the floating diffusion 145 is connected to a gate of the amplification transistor 147 and, when a select transistor 148 is put into the on-state, a signal (voltage signal) corresponding to the potential (FD potential) of the floating diffusion 145 is amplified and output (applied) to the vertical signal line 121-j. However, in the select transistor 148, a select signal (SEL) from the vertical scanning unit 103 is input to a gate electrode of the select transistor 148 via a control line 113-2, and the on/off action is controlled.

In other words, although a large number of sharing pixels 131-ij (the pixels 132 constituting the sharing pixels 131-ij) are connected to the vertical signal line 121-j, in order to select the sharing pixels 131-ij (the pixels 132 constituting the sharing pixels 131-ij) to be processed, it is only necessary to put the select transistor 148 in the sharing pixel 131-ij (the pixels 132 constituting the sharing pixel 131-ij) to be processed into the on-state in response to the select signal (SEL) from the vertical scanning unit 103.

A signal output from the sharing pixel 131-ij is input to the AD conversion unit 108 (the comparison unit 104 constituting the AD conversion unit 108) via the vertical signal line 121-j.

Note that the four pixels constituting the sharing pixel 131-ij can be arranged, for example, so as to have a Bayer array. Here, the Bayer array is an array pattern in which G pixels in green (G) are disposed in a checkered pattern and, in the remaining portion, R pixels in red (R) and B pixels in blue (B) are alternately disposed every other column. Specifically, the second pixel 132B and the third pixel 132C can be assigned as the G pixels, the first pixel 132A can be assigned as the R pixel, and the fourth pixel 132D can be assigned as the B pixel.

The AD conversion unit 108 is provided with an analog-digital converter (ADC) for each column of the sharing pixels 131-ij two-dimensionally arranged in the pixel array unit 102, in other words, for each vertical signal line 121-j, and converts analog signals output from the sharing pixels 131-ij for each column into digital signals to output.

The AD conversion unit 108 is provided with the comparison unit 104 and the counter unit 106 in order to perform AD conversion of the column AD method using correlated double sampling (CDS).

The comparison unit 104 is provided with a comparator 151-j and the addition trigger signal generation unit 152-j for each vertical signal line 121-j. Furthermore, the counter unit 106 is provided with a counter 161-j and a restoration unit 162-j for each vertical signal line 121-j.

Note that the DAC 105 generates a ramp wave (Ramp) on the basis of the clock signal from the control unit 101 and supplies the generated ramp wave to the comparison unit 104 (each comparator 151-j of the comparison unit 104) via a signal line 112.

The comparator 151-j compares the signal voltage Vx of the VSL signal from the vertical signal line 121-j with the reference voltage Vref of the ramp wave (Ramp) from the DAC 105, which are input to the comparator 151-j, and outputs the output signal Vco at a level according to the comparison result.

For example, in the comparator 151-j, when the signal voltage Vx of the VSL signal and the reference voltage Vref of the ramp wave become equal (intersect with each other), the polarity of the output signal Vco is inverted and, for example, in a case where the reference voltage Vref is higher than the signal voltage Vx, the output signal Vco is placed at an H level, while the output signal Vco is placed at an L level in a case where the reference voltage Vref is equal to or lower than the signal voltage Vx.

The output signal Vco from the comparator 151-j is input to the counter 161-j of the counter unit 106. The counter 161-j performs counting on the basis of the output signal Vco input to the counter 161-j, thereby measuring comparison time from the start of the comparison action to the end of the comparison action in the comparator 151-j. The measurement result by the counter 161-j is supplied to the restoration unit 162-j.

Here, as AD conversion of the column AD method using correlated double sampling (CDS), AD conversion is performed as follows, for example, in a case where readout from the first pixel 132A and the second pixel 132B is performed in the sharing pixel 131-ij.

That is, the reset level Srst is read out during the P-phase period, and the comparison action between the signal voltage Vx of the relevant VSL signal and the reference voltage Vref of the ramp wave is performed such that the resultant output signal Vco is counted. Furthermore, in addition to the reset level Srst, the pixel signal level SA of the first pixel 132A is read out during the D1 phase period, and the comparison action between the signal voltage Vx of the relevant VSL signal and the reference voltage Vref of the ramp wave is performed such that the resultant output signal Vco is counted (first AD conversion).

Moreover, in addition to the reset level Srst, for example, the pixel signal level SAB according to the combined charge QAB of the first pixel 132A and the second pixel 132B is read out during the D2 phase period, and the comparison action between the signal voltage Vx of the relevant VSL signal and the reference voltage Vref of the ramp wave is performed such that the resultant output signal Vco is counted (second AD conversion).

The restoration unit 162-j restores data for each pixel 132 constituting the sharing pixel 131-ij on the basis of the measurement result from the counter 161-j, and supplies the restored data to the horizontal scanning unit 107.

Here, for example, in a case where readout from the first pixel 132A and the second pixel 132B is performed and AD conversion of the column AD method using correlated double sampling (CDS) is performed in the sharing pixel 131-ij, a restoration process is performed as follows.

That is, for the data of the first pixel 132A, a digital signal containing the true signal component Sa can be obtained using the result of the first AD conversion, by taking a difference between a digital signal at the pixel signal level SA at the time of readout in the D1 phase and a digital signal at the reset level Srst at the time of readout in the P-phase. With this process, the data of the first pixel 132A (N-bit digital signal) is restored.

Furthermore, for the data of the second pixel 132B, a digital signal containing the true signal component Sab can be obtained using the result of the second AD conversion, by taking a difference between a digital signal at the pixel signal level SAB at the time of readout in the D2 phase and a digital signal at the reset level Srst at the time of readout in the P-phase. Then, by further taking a difference between the digital signal containing the true signal component Sab and the digital signal containing the true signal component Sa, a digital signal containing the true signal component Sb is obtained. With this process, the data of the second pixel 132B (N-bit digital signal) is restored.

The horizontal scanning unit 107 is constituted by a shift register and the like, and controls, for example, a column address and column scanning of the ADC provided in the AD conversion unit 108 for each vertical signal line 121-j. Under control of this horizontal scanning unit 107, the digital signal AD-converted by the AD conversion unit 108 is read out and output as imaging data (Output).

Here, in the AD conversion unit 108, the addition trigger signal generation unit 152-j of the comparison unit 104 is constituted by a NAND circuit 171-j, a NAND circuit 172-j, and a NOT circuit 173-j. Furthermore, the NAND circuits 171-j and 172-j constitute an RS flip flop circuit, and a reset signal (nRST) from the control unit 101 is input to the NAND circuit 172-j via a control line 111.

The output signal Vco from the comparator 151-j is monitored by this RS flip flop circuit and, when intersection between the signal voltage Vx of the VSL signal and the reference voltage Vref of the ramp wave (Ramp) is detected during the D1 phase period, the level of the addition trigger signal (AT) is caused to change (for example, the level of the addition trigger signal (AT) is caused to change from the L level to the H level).

Note that, since the timing at which the level of the addition trigger signal (AT) changes is different for each sharing pixel 131-ij connected to the vertical signal line 121-j, a strobe signal for distinguishing between the first AD conversion and the second AD conversion is supplied from the restoration unit 162-j to the addition trigger signal generation unit 152-j.

After the logic level of the addition trigger signal (AT) is inverted by the NOT circuit 173-j, the addition trigger signal (AT) is input to the gate electrode of the transfer transistor 143 or 144 of the sharing pixel 131-ij via the trigger signal line 122-j. With this process, in the sharing pixel 131-ij, the transfer transistor 143 or 144 is put into the on-state in response to the addition trigger signal (AT) input to the gate electrode of the transfer transistor 143 or 144.

At this time, for example, in a case where readout from the first pixel 132A and the second pixel 132B is performed and AD conversion of the column AD method using correlated double sampling (CDS) is performed in the sharing pixel 131-ij, the consequence is as follows.

That is, the floating diffusion 145 is put into a state in which, in response to the addition trigger signal (AT) from the addition trigger signal generation unit 152-j, the signal charge QA detected by the photodiode 141A of the first pixel 132A and the signal charge QB detected by the photodiode 141B of the second pixel 132B are added, and the resultant combined charge QAB is accumulated.

As described above, in the sharing pixel 131-ij, the signal charges detected by the photodiodes of two pixels are added in the floating diffusion 145 in response to the addition trigger signal (AT) from the addition trigger signal generation unit 152-j; accordingly, the timing of addition is given as a timing at which (immediately after that) the signal voltage Vx of the VSL signal and the reference voltage Vref of the ramp wave intersect during the D1 phase period in AD conversion by the AD conversion unit 108.

Therefore, compared to the conventional method (FIG. 1) in which the FD addition is performed after the D1 phase period, the start time of the FD addition can be made earlier and thus the processing time of AD conversion is shortened; as a result, higher speed readout is achieved.

Note that there is no disadvantage even if the addition of the signal charges (the signal charges QA and QB) is started in the floating diffusion 145 of the sharing pixel 131-ij at a timing at which (immediately after that) the signal voltage Vx of the VSL signal and the reference voltage Vref of the ramp wave intersect during the D1 phase period in AD conversion by the AD conversion unit 108, as described above. The reason is that a digital signal according to a signal charge (for example, the signal charge QA) previously accumulated in the floating diffusion 145 is already determined at the time point when intersection of voltages to be compared is detected, and there is thus no need to maintain the level of the digital signal.

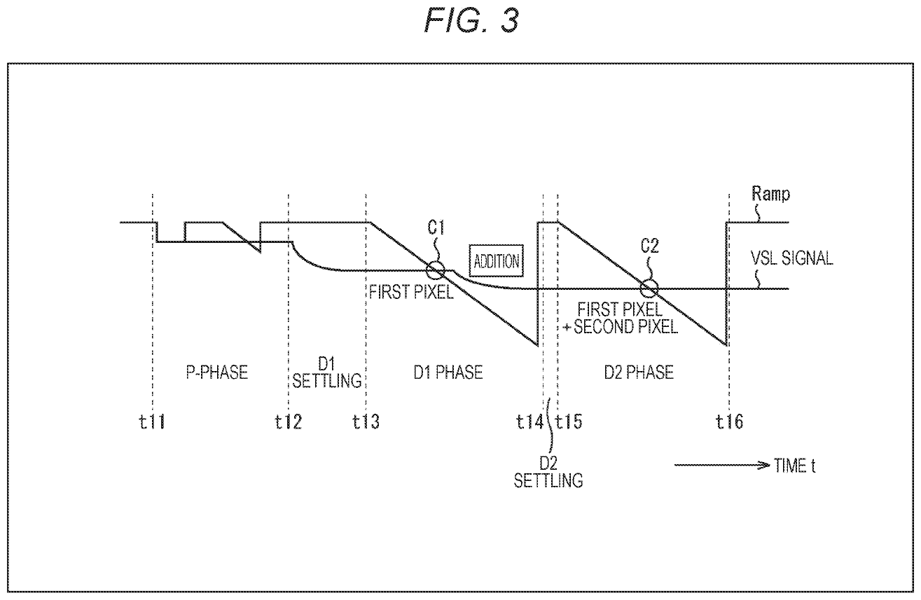

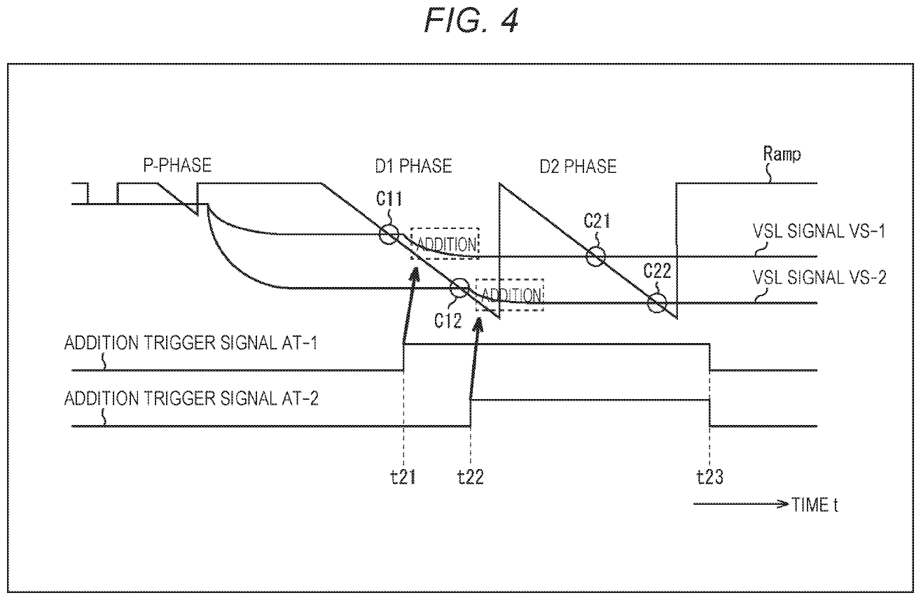

Next, the reason why the processing time for AD conversion is shortened in the CMOS image sensor 10 in FIG. 2 will be described with reference to FIGS. 3 and 4.

(Timing of AD Conversion and FD Addition)

FIG. 3 is a timing chart illustrating timings of AD conversion and FD addition in the CMOS image sensor 10 (FIG. 2).

In FIG. 3, the ramp wave (Ramp) from the DAC 105 and the output (VSL signal) of the vertical signal line 121-j, which are input to the comparator 151-j, are represented in time series. Furthermore, in FIG. 3, the direction of time is expressed as a direction from the left side to the right side of FIG. 3.

Note that, in the explanation of FIG. 3, taking as an example the sharing pixel 131-11 connected to the vertical signal line 121-1 among the sharing pixels 131-ij, the AD conversion and the FD addition for the first pixel 132A and the second pixel 132B will be described. As described above, in the sharing pixel 131-11, the floating diffusion 145 is shared between the photodiode 141A of the first pixel 132A and the photodiode 141B of the second pixel 132B.

At time t11, once the reset transistor 146 is put into the on-state in response to the reset signal (RST), the floating diffusion 145 is reset. With this action, the reset level Srst is read out during the P-phase period from time t11 to time t12.

Next, after the D1 settling period from time t12 to time t13, once the transfer transistor 142A of the first pixel 132A is put into the on-state, the pixel signal Sa according to the signal charge QA accumulated in the photodiode 141A is transferred to the floating diffusion 145.

At this time, in the floating diffusion 145, a potential according to the amount of the signal charge QA is generated and amplified by the amplification transistor 147 to be thereafter output to the vertical signal line 121-1 by the select transistor 148.

With this action, the pixel signal level SA according to the signal charge QA is read out during the D1 phase period from time t13 to time t14. Then, an offset component is removed by taking a difference between the pixel signal level SA at the time of readout in the D1 phase and the reset level Srst at the time of readout in the P-phase, and the true signal component Sa can be obtained.

During the P-phase period and the D1 phase period, a comparison action between the signal voltage Vx of the VSL signal from the vertical signal line 121-1 and the reference voltage Vref of the ramp wave (Ramp) from the DAC 105 is performed, and the output signal Vco at a level according to the comparison result is output by the comparator 151-1 of the AD conversion unit 108.

At this time, the addition trigger signal generation unit 152-1 constantly monitors the output signal Vco from the comparator 151-1 to detect a timing (C1 in FIG. 3) at which the signal voltage Vx of the VSL signal and the reference voltage Vref of the ramp wave (Ramp) intersect during the D1 phase period, and generates an addition trigger signal AT-1 in response to the detection result.

The generated addition trigger signal AT-1 is input to the sharing pixel 131-11 (the gate electrode of the transfer transistor 143 of the sharing pixel 131-11) via the trigger signal line 122-1. With this process, in the sharing pixel 131-11, the signal charge QB accumulated in the photodiode 141B is transferred to the floating diffusion 145.

As a result, in the floating diffusion 145, the signal charge QB detected by the photodiode 141B is joined with the signal charge QA detected by the photodiode 141A, which has already been accumulated. In other words, the floating diffusion 145 is put into a state in which the combined charge QAB obtained by combining the signal charges QA and QB detected by the two photodiodes 141A and 141B is accumulated.

As described above, in the CMOS image sensor 10 (FIG. 2), the addition in the floating diffusion 145 is fulfilled instantly after the signal voltage Vx of the VSL signal and the reference voltage Vref of the ramp wave (Ramp) intersect; accordingly, the time between the D1 phase period and the D2 phase period can be reduced by advancing the end time of the FD addition.

Furthermore, since resetting of the ramp wave (Ramp) from the DAC 105 also takes a certain amount of time, the D2 settling period cannot be completely eliminated; however, comparing the D2 settling period (a period from time t14 to time t15 in FIG. 3) in the CMOS image sensor 10 (FIG. 2) with the D2 settling period (a period from time t4 to time t5 in FIG. 1) in the conventional method, it is understood that the D2 settling period is significantly shortened. Then, by shortening the D2 settling period, it becomes possible as a result to perform readout at higher speed by shortening the processing time of AD conversion.

Next, in the D2 phase period from time t15 to time t16, the pixel signal level SB according to the signal charge QB detected by the photodiode 141B is read out. However, since the floating diffusion 145 is in a state in which the combined charge QAB obtained by combining the signal charges QA and QB detected by the two photodiodes 141A and 141B is accumulated, the pixel signal level SAB according to the combined charge QAB is read out here.

Therefore, an offset component is removed by taking a difference between the pixel signal level SAB at the time of readout in the D2 phase and the reset level Srst at the time of readout in the P-phase, and a true signal component Sab can be obtained. Furthermore, the pixel signal Sb (true signal component Sb) according to the signal charge QB detected by the photodiode 141B can be obtained by, for example, taking a difference between the combined component Sab (true signal component Sab) and the pixel signal Sa (true signal component Sa).

Also during the D2 phase period, a comparison action between the signal voltage Vx of the VSL signal from the vertical signal line 121-1 and the reference voltage Vref of the ramp wave (Ramp) from the DAC 105 is performed, and the output signal Vco at a level according to the comparison result is output by the comparator 151-1.

(Timings of Addition Trigger Signals and FD Addition)

FIG. 4 is a timing chart illustrating timings of the addition trigger signals and FD addition in the CMOS image sensor 10 (FIG. 2).

In FIG. 4, together with the ramp wave (Ramp) from the DAC 105 and the output (VSL signals (VS)) of the vertical signal line 121-j, which are input to the comparator 151-j, the addition trigger signals (AT) generated by the addition trigger signal generation unit 152-j are represented in time series.

Note that, in the explanation of FIG. 4, taking as an example the sharing pixel 131-11 connected to the vertical signal line 121-1 and the sharing pixel 131-12 connected to the vertical signal line 121-2 among the sharing pixels 131-ij, the addition trigger signals and the FD addition for the first pixels 132A and the second pixels 132B in these sharing pixels will be described.

Furthermore, in each of the sharing pixels 131-11 and 131-12, the floating diffusion 145 is shared between the photodiode 141A of the first pixel 132A and the photodiode 141B of the second pixel 132B.

As described above, in the sharing pixel 131-11, the reset level Srst is read out during the P-phase period, and the pixel signal level SA is read out during the D1 phase period.

Here, in the addition trigger signal generation unit 152-1, the output signal Vco from the comparator 151-1 is constantly monitored and a timing (C11 in FIG. 4) at which the signal voltage Vx of the VSL signal VS-1 from the vertical signal line 121-1 and the reference voltage Vref of the ramp wave (Ramp) from the DAC 105 intersect is detected during the D1 phase period.

Then, at time t21, when intersection between the voltages to be compared (C11 in FIG. 4) is detected by the addition trigger signal generation unit 152-1, the level of the addition trigger signal AT-1 is switched from the L level to the H level, and the addition trigger signal AT-1 is input to the sharing pixel 131-11 (the gate electrode of the transfer transistor 143 of the sharing pixel 131-11) via the trigger signal line 122-1.

With this process, in the sharing pixel 131-11, the signal charge QB accumulated in the photodiode 141B is transferred, while the floating diffusion 145 is put into a state in which the combined charge QAB obtained by combining the signal charges QA and QB detected by the two photodiodes 141A and 141B is accumulated.

Meanwhile, also in the sharing pixel 131-12, the reset level Srst is read out during the P-phase period, and the pixel signal level SA is read out during the D1 phase period.

Furthermore, in the addition trigger signal generation unit 152-2, the output signal Vco from the comparator 151-2 is constantly monitored and a timing (C12 in FIG. 4) at which the signal voltage Vx of the VSL signal VS-2 from the vertical signal line 121-2 and the reference voltage Vref of the ramp wave (Ramp) from the DAC 105 intersect is detected during the D1 phase period.

Then, at time t22, when intersection between the voltages to be compared (C12 in FIG. 4) is detected by the addition trigger signal generation unit 152-2, the level of the addition trigger signal AT-2 is switched from the L level to the H level, and the addition trigger signal AT-2 is input to the sharing pixel 131-12 (the gate electrode of the transfer transistor 143 of the sharing pixel 131-12) via the trigger signal line 122-2.

With this process, in the sharing pixel 131-12, the signal charge QB accumulated in the photodiode 141B is transferred, while the floating diffusion 145 is put into a state in which the combined charge QAB obtained by combining the signal charges QA and QB detected by the two photodiodes 141A and 141B is accumulated.

As described above, in the sharing pixels 131-11 and 131-12, the addition in the floating diffusion 145 is fulfilled instantly after the signal voltage Vx of the VSL signals (VS-1 and VS-2) and the reference voltage Vref of the ramp wave (Ramp) intersect; accordingly, the time between the D1 phase period and the D2 phase period can be reduced by advancing the end time of the FD addition.

At this time, since the waveforms of the VSL signal VS-1 from the sharing pixel 131-11 and the VSL signal VS-2 from the sharing pixel 131-12 differ depending on the signal level, the VSL signals VS-1 and VS-2 do not intersect with the reference voltage Vref of the ramp wave (Ramp) at the same timing (intersect at different timings as in C11 and C12 in FIG. 4), and thus the addition trigger signals (AT-1 and AT-2) are placed at the H level at different timings as in time t21 and time t22.

In other words, the signal charge QB accumulated in the photodiode 141B is joined (FD addition is performed) with the signal charge QA detected by the photodiode 141A, which has already been accumulated in the floating diffusion 145, at different timings for each sharing pixel 131. That is, even though located in the same one line in the row direction, the timing of the FD addition is delayed in the sharing pixel 131-12 compared to the sharing pixel 131-11.

Thereafter, in the sharing pixels 131-11 and 131-12, the pixel signal level SAB according to the combined charge QAB is read out during the D2 phase period after the D2 settling period.

Note that, as previously mentioned, the D2 settling period here is significantly shortened as compared to the D2 settling period in the conventional method (FIG. 1). Furthermore, at time t23 after the D2 phase period ends, the level of the addition trigger signals (AT-1 and AT-2) switches from the H level to the L level.

As described thus far, in the first embodiment, when AD conversion of the column AD method using correlated double sampling (CDS) is performed, since the addition of signal charges is performed in the floating diffusion of the sharing pixel during the D1 phase period at a timing at which (immediately after that) the signal voltage Vx of the VSL signal and the reference voltage Vref of the ramp wave (Ramp) intersect, the time between the D1 phase period and the D2 phase period can be reduced by advancing the end time of the FD addition. As a result, readout can be performed at higher speed by shortening the processing time for AD conversion.

Furthermore, in the first embodiment, basically, the above-described function can be implemented by adding the addition trigger signal generation unit 152, and fulfilling the FD addition in the sharing pixel 131 in response to the addition trigger signal; accordingly, readout can be performed at higher speed while an increase in the circuit scale of AD conversion is suppressed.

Moreover, even in a case where speeding-up of readout is not a requirement, if the processing time for AD conversion of the column AD method can be shortened, the number of stages (the number of columns) of the column AD can be decreased owing to the shortened processing time and, as a result, it is advantageous, for example, in terms of circuit scale and power consumption.

### 3. Second Embodiment

(Configuration of Solid-State Imaging Device)

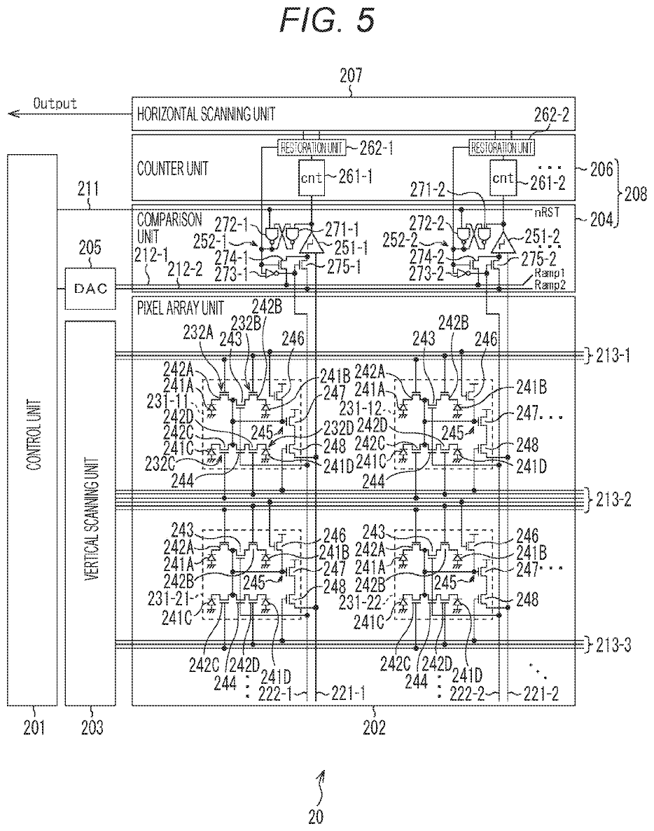

FIG. 5 is a diagram illustrating a configuration example of a solid-state imaging device according to a second embodiment.

A CMOS image sensor 20 is an example of the solid-state imaging device. The CMOS image sensor 20 in FIG. 5 has many parts configured similarly to the above-described CMOS image sensor 10 (FIG. 2), but a comparison unit 204 and a DAC 205 have different configurations.

In other words, while the DAC 105 in FIG. 2 outputs one type of ramp wave (Ramp), the DAC 205 in FIG. 5 is different from the DAC 105 in generating two types of ramp waves (Ramp1 and Ramp2) and supplying the generated ramp waves to each comparator 251-j of the comparison unit 204 via signal lines 212-1 and 212-2. Furthermore, the configuration of the comparison unit 204 in FIG. 5 is different from the configuration of the comparison unit 104 in FIG. 2 in order to handle the two types of ramp waves (Ramp1 and Ramp2) from the DAC 205.

In the comparison unit 204 in FIG. 5, in addition to the comparator 251-j and an addition trigger signal generation unit 252-j, a transistor 274-j and a transistor 275-j for switching the ramp waves are added. In different terms, the transistors 274-j and 275-j constitute a ramp wave switching circuit.

The transistors 274-j and 275-j perform the on/off action in response to a signal input to the gate electrodes of the transistors 274-j and 275-j, whereby the ramp wave input to the comparator 251-j is switched from a first ramp wave (Ramp1) to a second ramp wave (Ramp 2) during the D1 phase period at a timing at which the signal voltage Vx of the VSL signal from a vertical signal line 221-j and the reference voltage Vref of the first ramp wave (Ramp1) from the DAC 205 intersect.

In other words, in an AD conversion unit 208, AD conversion (first AD conversion) using the first ramp wave (Ramp1) is performed during the P-phase period and the D1 phase period, while AD conversion (second AD conversion) using the second ramp wave (Ramp 2) is performed during the D2 phase period.

Furthermore, in the AD conversion unit 208, the addition trigger signal generation unit 252-j of the comparison unit 204 is configured similarly to the addition trigger signal generation unit 152-j in FIG. 2. In other words, the addition trigger signal generation unit 252-j is configured from a NAND circuit 271-j and a NAND circuit 272-j as an RS flip flop circuit, and a NOT circuit 273-j.

In the addition trigger signal generation unit 252-j, the output signal Vco from the comparator 251-j is constantly monitored by the RS flip flop circuit and, when intersection between the signal voltage Vx of the VSL signal and the reference voltage Vref of the first ramp wave (Ramp1) is detected during the D1 phase period, the level of the addition trigger signal (AT) is switched.

Note that, in FIG. 5, the configuration except the comparison unit 204 and the DAC 205 described above, in other words, the configurations of the control unit 201, the pixel array unit 202, the vertical scanning unit 203, the counter unit 206, and the horizontal scanning unit 207 are basically similar to the configurations of the control unit 101, the pixel array unit 102, the vertical scanning unit 103, the counter unit 106, and the horizontal scanning unit 107 illustrated in FIG. 2, and thus the description thereof will be omitted.

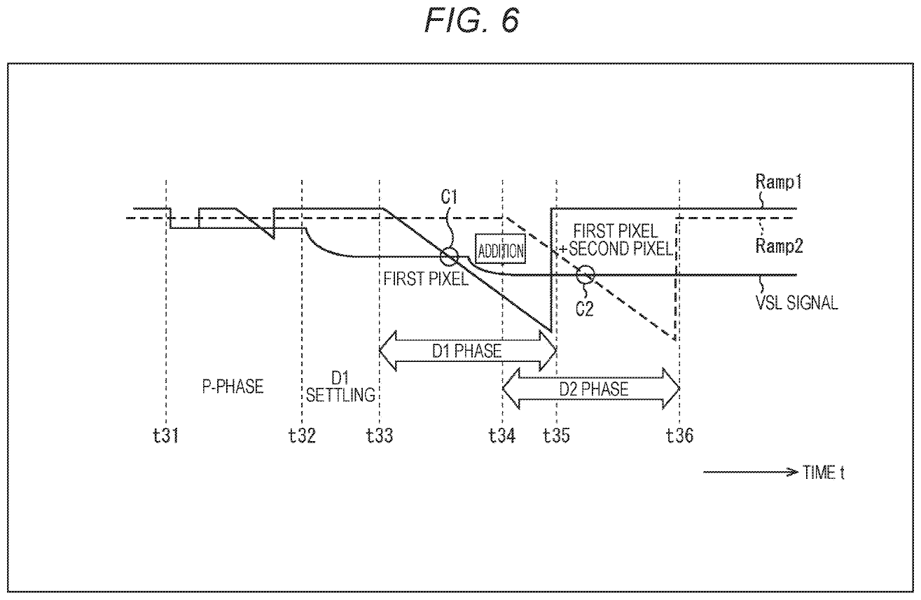

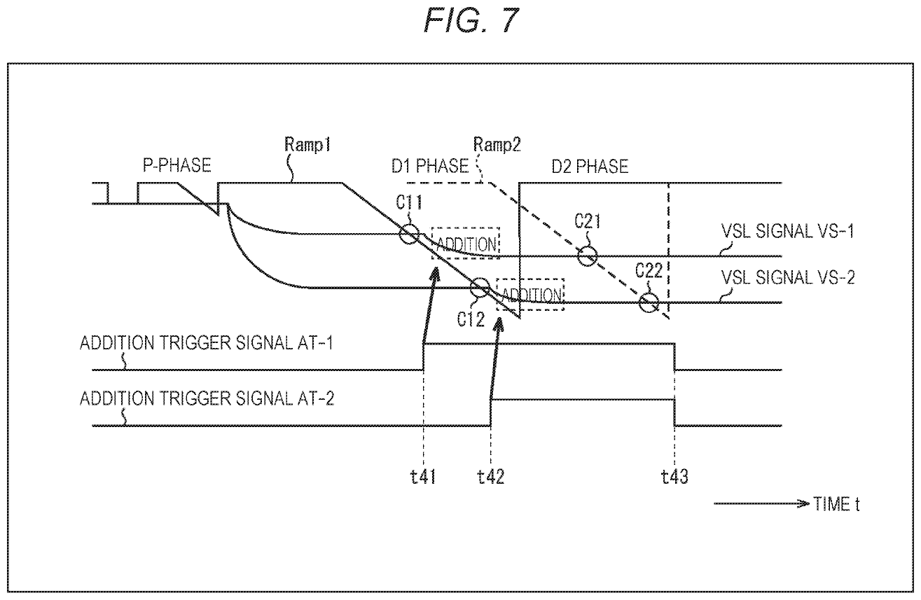

Next, the reason why the processing time for AD conversion is shortened in the CMOS image sensor 20 in FIG. 5 will be described with reference to FIGS. 6 and 7.

(Timing of AD Conversion and FD Addition)

FIG. 6 is a timing chart illustrating timings of AD conversion and FD addition in the CMOS image sensor 20 (FIG. 5).

In FIG. 6, two types of ramp waves (Ramp1 and Ramp2) from the DAC 205 and the output (VSL signal) of the vertical signal line 221-j, which are input to the comparator 251-j, are represented in time series. Furthermore, also in FIG. 6, the direction of time is expressed as a direction from the left side to the right side of FIG. 6.

Note that, in the explanation of FIG. 6, taking as an example a sharing pixel 231-11 connected to a vertical signal line 221-1 among sharing pixels 231-ij, the addition trigger signals and the FD addition for a first pixel 232A and a second pixel 232B will be described. Furthermore, in the sharing pixel 231-11, a floating diffusion 245 is shared between a photodiode 241A of the first pixel 232A and a photodiode 241B of the second pixel 232B.

In the sharing pixel 231-11, the reset level Srst is read out during the P-phase period, and the pixel signal level SA is read out during the D1 phase period.

During the P-phase period and the D1 phase period, a comparison action between the signal voltage Vx of the VSL signal from the vertical signal line 221-1 and the reference voltage Vref of the first ramp wave (Ramp1) from the DAC 205 is performed, and the output signal Vco at a level according to the comparison result is output by the comparator 251-1 of the AD conversion unit 208.

At this time, in the addition trigger signal generation unit 252-1, the output signal Vco from the comparator 251-1 is constantly monitored and a timing (C1 in FIG. 6) at which the signal voltage Vx of the VSL signal VS-1 and the reference voltage Vref of the first ramp wave (Ramp1) intersect is detected during the D1 phase period.

Then, when intersection between the voltages to be compared (C1 in FIG. 6) is detected, the level of the addition trigger signal AT-1 is switched to the H level, and the addition trigger signal AT-1 is input to the sharing pixel 231-11 (the gate electrode of a transfer transistor 243 of the sharing pixel 231-11) via a trigger signal line 222-1.

With this process, in the sharing pixel 231-11, the signal charge QB accumulated in the photodiode 241B is transferred, while the floating diffusion 245 is put into a state in which the combined charge QAB obtained by combining the signal charges QA and QB detected by the two photodiodes 241A and 241B is accumulated.

Then, during the D2 phase period after the addition in the floating diffusion 245 has been started, the pixel signal level SAB according to the combined charge QAB is read out.

Here, when intersection between the voltages to be compared (C1 in FIG. 6) is detected during the D1 phase period, the ramp wave is switched from the first ramp wave (Ramp1) to the second ramp wave (Ramp2).

Therefore, during the D2 phase period, a comparison action between the signal voltage Vx of the VSL signal from the vertical signal line 221-1 and the reference voltage Vref of the second ramp wave (Ramp2) from the DAC 205 is performed, and the output signal Vco at a level according to the comparison result is output by the comparator 251-1.

As described above, during the D1 phase period, the VSL signal obtained from the first pixel 232A is compared (first AD conversion) using the first ramp wave (Ramp1), and the FD addition of the signal charges of the first pixel 232A and the second pixel 232B is instantly started when the signal voltage Vx of the VSL signal and the reference voltage Vref of the first ramp wave (Ramp1) intersect. Furthermore, at the timing of this intersection, the ramp wave is switched from the first ramp wave (Ramp1) to the second ramp wave (Ramp2).

Then, during the D2 phase period, since the ramp wave has been switched from the first ramp wave (Ramp1) to the second ramp wave (Ramp2), the VSL signal obtained from the first pixel 232A and the second pixel 232B is compared (second AD conversion) using the second ramp wave (Ramp 2).

With this procedure, the time between the D1 phase period and the D2 phase period can be further reduced by using the ramp wave (Ramp2) during the D2 phase period as well as advancing the end time of the FD addition.

Note that, in this example, the example of switching the first ramp wave (Ramp1) and the second ramp wave (Ramp2) has been described; however, in a case where the addition time in the floating diffusion 245 is sufficiently short, the first ramp wave (Ramp1) and the second ramp (Ramp2) may be caused to overlap.

(Timings of Addition Trigger Signals and FD Addition)

FIG. 7 is a timing chart illustrating timings of the addition trigger signals and FD addition in the CMOS image sensor 20 (FIG. 5).

In FIG. 7, together with two types of ramp waves (Ramp1 and Ramp2) from the DAC 205 and the output (VSL signals (VS)) of the vertical signal line 221-j, which are input to the comparator 251-j, the addition trigger signals (AT) generated by the addition trigger signal generation unit 252-j are represented in time series.

Note that, in the explanation of FIG. 7, taking as an example the sharing pixel 231-11 connected to the vertical signal line 221-1 and the sharing pixel 231-12 connected to the vertical signal line 221-2 among the sharing pixels 231-ij, the addition trigger signals and the FD addition for the first pixels 232A and the second pixels 232B in these sharing pixels will be described.

Furthermore, in each of the sharing pixels 231-11 and 231-12, the floating diffusion 245 is shared between the photodiode 241A of the first pixel 232A and the photodiode 241B of the second pixel 232B.

In the sharing pixel 231-11, the reset level Srst is read out during the P-phase period, and the pixel signal level SA is read out during the D1 phase period.

Here, during the P-phase period and the D1 phase period, a comparison action between the signal voltage Vx of the VSL signal from the vertical signal line 221-1 and the reference voltage Vref of the first ramp wave (Ramp1) from the DAC 205 is performed, and the output signal Vco at a level according to the comparison result is output by the comparator 251-1 of the AD conversion unit 208.

Furthermore, in the addition trigger signal generation unit 252-1, the output signal Vco from the comparator 251-1 is constantly monitored and a timing (C11 in FIG. 7) at which the signal voltage Vx of the VSL signal VS-1 and the reference voltage Vref of the first ramp wave (Ramp1) intersect is detected during the D1 phase period.

Then, at time t41, when intersection between the voltages to be compared (C11 in FIG. 7) is detected by the addition trigger signal generation unit 252-1, the level of the addition trigger signal AT-1 is switched from the L level to the H level, and the addition trigger signal AT-1 is input to the sharing pixel 231-11 (the gate electrode of the transfer transistor 243 of the sharing pixel 231-11) via the trigger signal line 222-1.

With this process, in the sharing pixel 231-11, the signal charge QB accumulated in the photodiode 241B is transferred, while the floating diffusion 245 is put into a state in which the combined charge QAB obtained by combining the signal charges QA and QB detected by the two photodiodes 241A and 241B is accumulated.

Meanwhile, also in the sharing pixel 231-12, the reset level Srst is read out during the P-phase period, and the pixel signal level SA is read out during the D1 phase period.

Here, during the P-phase period and the D1 phase period, a comparison action between the signal voltage Vx of the VSL signal from the vertical signal line 221-2 and the reference voltage Vref of the first ramp wave (Ramp1) from the DAC 205 is performed, and the output signal Vco at a level according to the comparison result is output by the comparator 251-2 of the AD conversion unit 208.

Furthermore, in the addition trigger signal generation unit 252-2, the output signal Vco from the comparator 251-2 is constantly monitored and a timing (C12 in FIG. 7) at which the signal voltage Vx of the VSL signal VS-2 and the reference voltage Vref of the first ramp wave (Ramp1) intersect is detected during the D1 phase period.

Then, at time t42, when intersection between the voltages to be compared (C12 in FIG. 7) is detected by the addition trigger signal generation unit 252-2, the level of the addition trigger signal AT-2 is switched from the L level to the H level, and the addition trigger signal AT-2 is input to the sharing pixel 231-12 (the gate electrode of the transfer transistor 243 of the sharing pixel 231-12) via the trigger signal line 222-2.

With this process, in the sharing pixel 231-12, the signal charge QB accumulated in the photodiode 241B is transferred, while the floating diffusion 245 is put into a state in which the combined charge QAB obtained by combining the signal charges QA and QB detected by the two photodiodes 241A and 241B is accumulated.

As described above, in the sharing pixels 231-11 and 231-12, the addition in the floating diffusion 245 is fulfilled instantly after the signal voltage Vx of the VSL signals (VS-1 and VS-2) and the reference voltage Vref of the first ramp wave (Ramp1) intersect (C11 and C12 in FIG. 7); accordingly, the processing time for AD conversion can be shortened by advancing the end time of the FD addition.

At this time, since the waveforms of the VSL signal VS-1 from the sharing pixel 231-11 and the VSL signal VS-2 from the sharing pixel 231-12 differ depending on the signal level, the VSL signals VS-1 and VS-2 do not intersect with the reference voltage Vref of the first ramp wave (Ramp1) at the same timing (intersect at different timings as in C11 and C12 in FIG. 7), and thus the addition trigger signals (AT-1 and AT-2) are placed at the H level at different timings as in time t41 and time t42.

Then, during the D2 phase period after the addition in the floating diffusion 245 has been started, the pixel signal level SAB is read out in the sharing pixels 231-11 and 231-12.

However, in the comparators 251-1 and 251-2, the ramp wave to be input is switched from the first ramp wave (Ramp1) to the second ramp wave (Ramp2) by the ramp wave switching circuit during the D1 phase period at a timing (C11 and C12 in FIG. 7) at which the signal voltage Vx of the VSL signal and the reference voltage Vref of the first ramp wave (Ramp1) intersect.

In other words, in the comparators 251-1 and 251-2, AD conversion (first AD conversion) using the first ramp wave (Ramp1) is performed during the P-phase period and the D1 phase period, while AD conversion (second AD conversion) using the second ramp wave (Ramp2) is performed during the D2 phase period.

As described above, in the comparator 251-1, by comparing the VSL signal VS-1 obtained from the first pixel 232A and the second pixel 232B of the sharing pixel 231-11 during the D2 phase period using the second ramp wave (Ramp2) instead of the first ramp wave (Ramp1), the time between the D1 phase period and the D2 phase period is decreased, and the processing time for AD conversion can be further shortened.

Furthermore, similarly, also in the comparator 251-2, by comparing the VSL signal VS-2 obtained from the first pixel 232A and the second pixel 232B of the sharing pixel 231-12 during the D2 phase period using the second ramp wave (Ramp2), the time between the D1 phase period and the D2 phase period is decreased, and the processing time for AD conversion can be further shortened.

As described thus far, in the second embodiment, when AD conversion of the column AD method using correlated double sampling (CDS) is performed, the FD addition is performed during the D1 phase period at a timing at which (immediately after that) the signal voltage Vx of the VSL signal and the reference voltage Vref of the first ramp wave (Ramp1) intersect, and also the first ramp wave (Ramp1) is switched to the second ramp wave (Ramp2) such that AD conversion using the second ramp wave (Ramp2) is performed during the D2 phase period. Therefore, the time between the D1 phase period and the D2 phase period can be further reduced. As a result, readout can be performed at higher speed by shortening the processing time for AD conversion.

### 4. Variations

Although the above explanation has described a case where the pixels 132 (the photodiodes 141 of the pixels 132) sharing the floating diffusion 145 form four-pixel sharing in the sharing pixel 131-ij, the present technology is not limited to four-pixel sharing and the number of pixels to share is arbitrary, such as two-pixel sharing and eight-pixel sharing.

Furthermore, the above explanation has described a case where, in the sharing pixel 131-ij, the signal charge QA of the photodiode 141A of the first pixel 132A and the signal charge QB of the photodiode 141B of the second pixel 132B are added in the floating diffusion 145; however, signal charges detected by photodiodes of other pixels, such as signal charges of the photodiodes of the third pixel 132C and the fourth pixel 132D, may be added. Moreover, FD addition may be performed on signal charges of three or more photodiodes.

Furthermore, in the above explanation, an example in which two types of ramp waves (Ramp1 and Ramp2) are switched by the ramp wave switching circuit has been described as the second embodiment; however, three or more types of ramp waves may be used depending on mounting situation.

### 5. Configuration of Electronic Apparatus

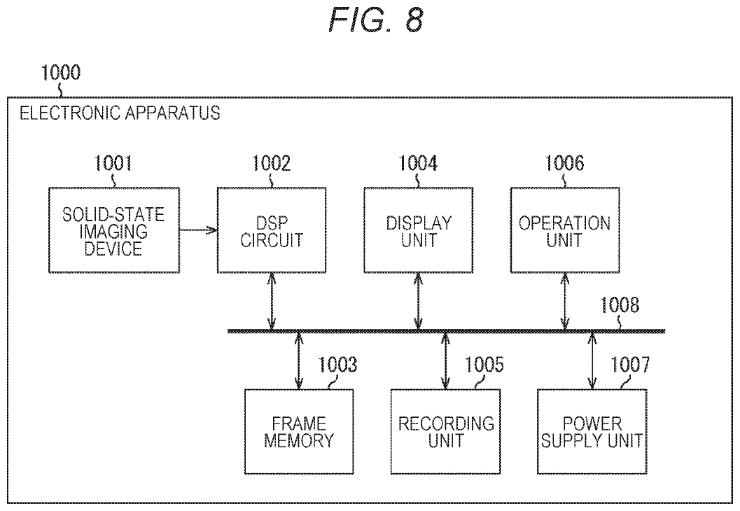

FIG. 8 is a block diagram illustrating a configuration example of an electronic apparatus having the solid-state imaging device to which the present technology is applied.

The electronic apparatus 1000 is an electronic apparatus exemplified by an imaging device such as a digital still camera or a video camera, or a portable terminal device such as a smartphone or a tablet type terminal.

The electronic apparatus 1000 is configured from a solid-state imaging device 1001, a DSP circuit 1002, a frame memory 1003, a display unit 1004, a recording unit 1005, an operation unit 1006, and a power supply unit 1007. Furthermore, in the electronic apparatus 1000, the DSP circuit 1002, the frame memory 1003, the display unit 1004, the recording unit 1005, the operation unit 1006, and the power supply unit 1007 are interconnected via a bus line 1008.

The solid-state imaging device 1001 corresponds to the CMOS image sensor 10 (FIG. 2) or the CMOS image sensor 20 (FIG. 5) described above, and FD addition performed in each sharing pixel 131 (sharing pixel 231) is performed in response to the addition trigger signal (AT) obtained at the time of AD conversion.

The DSP circuit 1002 is a camera signal processing circuit that processes a signal supplied from the solid-state imaging device 1001. The DSP circuit 1002 outputs image data obtained by processing a signal from the solid-state imaging device 1001. The frame memory 1003 temporarily holds the image data processed by the DSP circuit 1002 in frame units.

The display unit 1004, including a panel-type display device such as a liquid crystal panel or an organic electro luminescence (EL) panel, displays a moving image or a still image captured by the solid-state imaging device 1001. The recording unit 1005 records image data of a moving image or a still image captured by the solid-state imaging device 1001 on a recording medium such as a semiconductor memory or a hard disk.

The operation unit 1006 outputs operation commands for various functions included in the electronic apparatus 1000 in accordance with operations by a user. The power supply unit 1007 properly supplies various types of power to the DSP circuit 1002, the frame memory 1003, the display unit 1004, the recording unit 1005, and the operation unit 1006 as action power for these units to be supplied.

The electronic apparatus 1000 is configured as described above. The present technology is applied to the solid-state imaging device 1001 as described above. Specifically, the CMOS image sensor 10 (FIG. 2) or the CMOS image sensor 20 (FIG. 5) can be applied to the solid-state imaging device 1001. By applying the present technology to the solid-state imaging device 1001, the FD addition performed in each sharing pixel 131 (sharing pixel 231) is performed in response to the addition trigger signal (AT) obtained at the time of AD conversion; accordingly, readout can be performed at higher speed by shortening the processing time for AD conversion.

### 6. Examples of Use of Image Sensor

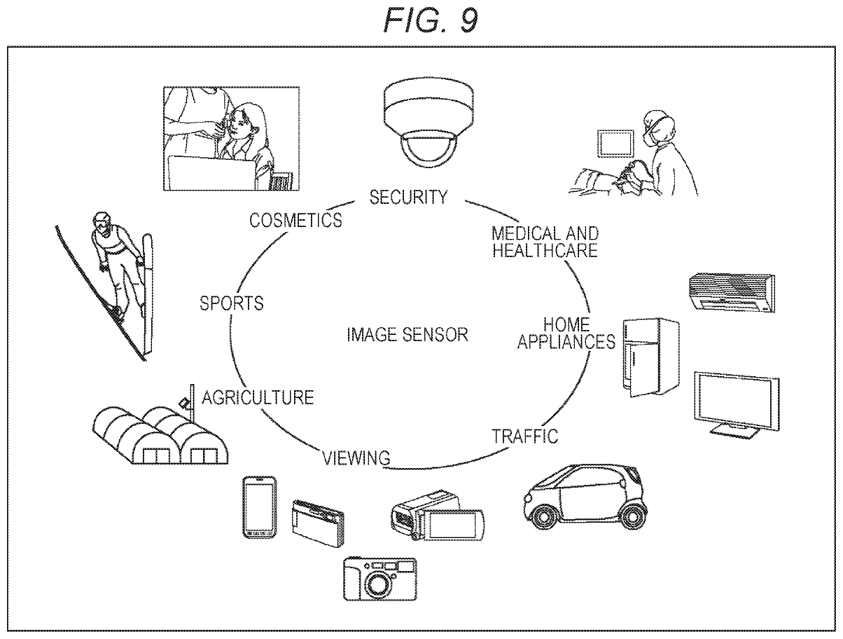

FIG. 9 is a diagram illustrating examples of use of the solid-state imaging device to which the present technology is applied.

For example, the CMOS image sensor 10 or the CMOS image sensor 20 can be used in diverse cases of sensing light such as visible light, infrared light, ultraviolet light, and X-ray, as described below. That is, as illustrated in FIG. 9, the CMOS image sensor 10 or the CMOS image sensor 20 can be used in a device utilized in not only the field of viewing for capturing an image available for viewing purposes but also, for example, the field of traffic, the field of home appliances, the field of medical and healthcare, the field of security, the field of cosmetics, the field of sports, or the field of agriculture.

Specifically, in the field of viewing, for example, the CMOS image sensor 10 or the CMOS image sensor 20 can be used in a device (for example, the electronic apparatus 1000 in FIG. 8) for capturing an image available for viewing purposes, such as a digital camera, a smartphone, or a mobile phone with a camera function.

In the field of traffic, for example, the CMOS image sensor 10 or the CMOS image sensor 20 can be used in a device available for traffic purposes, such as an in-vehicle sensor that captures images of the front, back, surroundings, inside, and the like of an automobile for, for example, safe driving such as automatic stop and recognition of the state of the driver, a surveillance camera that monitors traveling vehicles and roads, and a distance measuring sensor that measures a distance between vehicles, and the like.

In the field of home appliances, for example, the CMOS image sensor 10 or the CMOS image sensor 20 can be used in a device available for home appliances, such as a television receiver, a refrigerator, or an air conditioner, in order to capture an image of a user's gesture such that an apparatus is operated in accordance with the captured gesture. Furthermore, in the field of medical and healthcare, for example, the CMOS image sensor 10 or the CMOS image sensor 20 can be used in a device available for medical and healthcare purposes, such as an endoscope or a device that performs angiography by receiving infrared light.

In the field of security, for example, the CMOS image sensor 10 or the CMOS image sensor 20 can be used in a device available for security purposes, such as a surveillance camera for crime prevention use or a camera for person authentication use. Furthermore, in the field of cosmetics, for example, the CMOS image sensor 10 or the CMOS image sensor 20 can be used in a device available for cosmetic purposes, such as a skin measuring instrument that captures an image of skin or a microscope that captures an image of the scalp.

In the field of sports, for example, the CMOS image sensor 10 or the CMOS image sensor 20 can be used in a device available for sports purposes, such as an action camera or wearable camera for sports use or the like. Furthermore, in the field of agriculture, for example, the CMOS image sensor 10 or the CMOS image sensor 20 can be used in a device available for agricultural purposes, such as a camera for monitoring the condition of fields and crops.

Note that the embodiments according to the present technology are not limited to the aforementioned embodiments and a variety of modifications can be made without departing from the scope of the present technology.

Furthermore, the present technology can also be configured as described below.

(1)

A solid-state imaging device including:

a pixel array unit in which pixels each having a photoelectric conversion unit are two-dimensionally arranged in a matrix, and column signal lines are wired for each column in the matrix arrangement of the pixels; and

an AD conversion unit that converts signals output via the column signal lines into digital signals from analog signals, in which

pixel sharing in units of a predetermined number of pixels is fulfilled by sharing a charge-voltage conversion unit for converting a charge detected by the photoelectric conversion unit into a voltage, between the photoelectric conversion units of a plurality of the pixels, and

when a digital signal according to a first charge detected by a first photoelectric conversion unit of a first pixel among the first pixel and a second pixel constituting a sharing pixel to be AD-converted is determined in the AD conversion unit, the charge-voltage conversion unit of the sharing pixel adds the first charge from the first photoelectric conversion unit of the first pixel and a second charge from a second photoelectric conversion unit of the second pixel.

(2)

The solid-state imaging device according to (1) above, in which

an AD conversion method by the AD conversion unit includes a column AD method using correlated double sampling (CDS), and

at a timing at which a signal voltage of a signal input via one of the column signal lines and a reference voltage from outside intersect in the AD conversion unit at time of readout from the first pixel in a D-phase, the charge-voltage conversion unit adds the first charge and the second charge.

(3)

The solid-state imaging device according to (2) above, further including

a trigger generation unit that generates an addition trigger signal according to a timing at which the signal voltage and the reference voltage intersect, in which

the charge-voltage conversion unit adds the first charge and the second charge in response to the addition trigger signal.

(4)

The solid-state imaging device according to (2) or (3) above, in which

a timing of addition of the first charge and the second charge in the charge-voltage conversion unit is different for each of the sharing pixels connected to the column signal lines.

(5)

The solid-state imaging device according to any one of (2) to (4) above, in which

the reference voltage to be compared with the signal voltage in the AD conversion unit is obtained from one type of ramp wave.

(6)

The solid-state imaging device according to any one of (2) to (4) above, in which

the reference voltage to be compared with the signal voltage in the AD conversion unit is obtained from a plurality of types of ramp waves.

(7)

The solid-state imaging device according to (6) above, in which

in the AD conversion unit, a first ramp wave is used at time of readout in a P-phase and readout from the first pixel in the D-phase, and a second ramp wave different from the first ramp wave is used at time of readout from the first pixel and the second pixel in the D-phase.

(8)

An electronic apparatus equipped with a solid-state imaging device including:

a pixel array unit in which pixels each having a photoelectric conversion unit are two-dimensionally arranged in a matrix, and column signal lines are wired for each column in the matrix arrangement of the pixels; and

an AD conversion unit that converts signals output via the column signal lines into digital signals from analog signals, in which

pixel sharing in units of a predetermined number of pixels is fulfilled by sharing a charge-voltage conversion unit for converting a charge detected by the photoelectric conversion unit into a voltage, between the photoelectric conversion units of a plurality of the pixels, and

when a digital signal according to a first charge detected by a first photoelectric conversion unit of a first pixel among the first pixel and a second pixel constituting a sharing pixel to be AD-converted is determined in the AD conversion unit, the charge-voltage conversion unit of the sharing pixel adds the first charge from the first photoelectric conversion unit of the first pixel and a second charge from a second photoelectric conversion unit of the second pixel.

### REFERENCE SIGNS LIST

10, 20 CMOS image sensor
101, 201 Control unit
102, 202 Pixel array unit
103, 203 Vertical scanning unit
104, 204 Comparison unit
105, 205 DAC
106, 206 Counter unit
107, 207 Horizontal scanning unit
108, 208 AD conversion unit
131, 231 Sharing pixel
132A, 232A First pixel
132B, 232B Second pixel
132C, 232C Third pixel
132D, 232D Fourth pixel
141, 241 Photodiode
142, 242 Transfer transistor
143, 243 Transfer transistor
144, 244 Transfer transistor
145, 245 Floating diffusion
146, 246 Reset transistor
147, 247 Amplification transistor
148, 248 Select transistor
151, 251 Comparator
152, 252 Addition trigger signal generation unit
161, 261 Counter
162, 262 Restoration unit
1000 Electronic apparatus
1001 Solid-state imaging device

1. A solid-state imaging device comprising:
a pixel array unit in which pixels each having a photoelectric conversion unit are two-dimensionally arranged in a matrix, and column signal lines are wired for each column in the matrix arrangement of the pixels; and
an AD conversion unit that converts signals output via the column signal lines into digital signals from analog signals, wherein
pixel sharing in units of a predetermined number of pixels is fulfilled by sharing a charge-voltage conversion unit for converting a charge detected by the photoelectric conversion unit into a voltage, between the photoelectric conversion units of a plurality of the pixels, and
when a digital signal according to a first charge detected by a first photoelectric conversion unit of a first pixel among the first pixel and a second pixel constituting a sharing pixel to be AD-converted is determined in the AD conversion unit, the charge-voltage conversion unit of the sharing pixel adds the first charge from the first photoelectric conversion unit of the first pixel and a second charge from a second photoelectric conversion unit of the second pixel.

2. The solid-state imaging device according to claim 1, wherein
an AD conversion method by the AD conversion unit includes a column AD method using correlated double sampling (CDS), and
at a timing at which a signal voltage of a signal input via one of the column signal lines and a reference voltage from outside intersect in the AD conversion unit at time of readout from the first pixel in a D-phase, the charge-voltage conversion unit adds the first charge and the second charge.

3. The solid-state imaging device according to claim 2, further comprising
a trigger generation unit that generates an addition trigger signal according to a timing at which the signal voltage and the reference voltage intersect, wherein
the charge-voltage conversion unit adds the first charge and the second charge in response to the addition trigger signal.

4. The solid-state imaging device according to claim 2, wherein
a timing of addition of the first charge and the second charge in the charge-voltage conversion unit is different for each of the sharing pixels connected to the column signal lines.

5. The solid-state imaging device according to claim 4, wherein
the reference voltage to be compared with the signal voltage in the AD conversion unit is obtained from one type of ramp wave.

6. The solid-state imaging device according to claim 4, wherein
the reference voltage to be compared with the signal voltage in the AD conversion unit is obtained from a plurality of types of ramp waves.

7. The solid-state imaging device according to claim 6, wherein
in the AD conversion unit, a first ramp wave is used at time of readout in a P-phase and readout from the first pixel in the D-phase, and a second ramp wave different from the first ramp wave is used at time of readout from the first pixel and the second pixel in the D-phase.

8. An electronic apparatus equipped with a solid-state imaging device comprising:
a pixel array unit in which pixels each having a photoelectric conversion unit are two-dimensionally arranged in a matrix, and column signal lines are wired for each column in the matrix arrangement of the pixels; and
an AD conversion unit that converts signals output via the column signal lines into digital signals from analog signals, wherein
pixel sharing in units of a predetermined number of pixels is fulfilled by sharing a charge-voltage conversion unit for converting a charge detected by the photoelectric conversion unit into a voltage, between the photoelectric conversion units of a plurality of the pixels, and
when a digital signal according to a first charge detected by a first photoelectric conversion unit of a first pixel among the first pixel and a second pixel constituting a sharing pixel to be AD-converted is determined in the AD conversion unit, the charge-voltage conversion unit of the sharing pixel adds the first charge from the first photoelectric conversion unit of the first pixel and a second charge from a second photoelectric conversion unit of the second pixel.
